(19) United States
(12) Patent Application Publication
(10) Pub. No.: US 2003/0083166 A1
(43) Pub. Date: May 1, 2003

(54) Multilayered flexible drive sprocket

(75) Inventor: Thomas E. Oertley, Dunlap, IL (US)

Correspondence Address: Calvin E Glastetter, Caterpillar Inc, Patent Department AB6490, 100 NE Adams Street, Peoria, IL, 61629-6490, US

(73) Assignee: Jeff A. Greene

(21) Appl. No.: 09/568,110

(22) Filed: May 10, 2000

(51) Int. Cl. F16H 55/30; F16H 55/12; F16H 55/14

(52) U.S. Cl. 474/162; 474/152

(57) ABSTRACT

A drive sprocket assembly for driving an endless chain assembly for propelling a vehicle has multilayered flexible teeth in which each layer is separately deflectable upon impact by a bushing of the endless chain assembly. The independent flexibility of each tooth in the multilayered structure is less than that of a single wide monolithic tooth and, as a result of expected variance due to acceptable manufacturing tolerances in tooth profiles and web shapes, the impacts of the track bushing do not occur simultaneously. The track bushing first engages one or more of the teeth in the multilayered tooth structure, whereupon the first impacted teeth absorb at least a portion of the kinetic energy prior to the bushing impacting the remaining teeth in the multilayered structure.

### TECHNICAL FIELD

This invention relates generally to a drive sprocket and more particularly to a drive sprocket having wide sprocket teeth formed of multiple layers of separately moveable, relatively thin sprocket teeth.

### BACKGROUND ART

Earth moving and construction type vehicles, which have endless self-laying track chain assemblies for support and propulsion, generally utilize a sprocket wheel to engage and drive the track chain. Several different types of sprocket wheels have been used in the past, including a single wheel member having a plurality of integral teeth, a circular support member for supporting a number of wheel segments, each segment having several full width teeth, and hub members accommodating a plurality of separate, individual full width teeth. However, many prior drive sprocket constructions have been ineffective, or quite limited, in their ability to reduce noise levels during driving operation against an endless track chain assembly.

One attempt to provide a reduced noise sprocket assembly is disclosed in U.S. Pat. No. 4,881,930 for a SPROCKET ASSEMBLY, granted Nov. 21, 1989 to Thomas E. Oertley, the inventor of the present invention, and assigned to the assignee of the present invention. The sprocket assembly described in the referenced Oertley patent produces low levels of noise by utilizing individually replaceable full width tooth structures which are resiliently isolated from the support housing and from adjoining tooth structures. That arrangement requires many components, including resilient pads between adjacently disposed teeth, retaining members and pins to hold the resilient pads in place, and a resilient cushion band positioned between the hub of the drive sprocket and the tooth structures.

The present invention is directed to overcoming one or more of the problems of the prior structures, as set forth above.

### DISCLOSURE OF THE INVENTION

In one aspect of the present invention, a drive sprocket assembly includes a housing having a circular hub portion, and a plurality of adjacently disposed separate drive tooth structures mounted on the hub portion. Each of the separate drive tooth structures have a base portion defining a curved surface adapted to mate with a radially outer surface of the hub portion of the housing and at least one resilient tooth portion capable of limited deflection.

In another aspect of the present invention, a drive sprocket assembly for a track type vehicle having an endless track includes a housing having a circular hub, and a plurality of segments defining separate drive tooth structures disposed in side-by-side relationship on the hub portion. Each of the segments have at least one drive tooth defined on each of the segments adapted to engage a predefined portion of an endless track of the track-type vehicle.

In still another aspect of the present invention, a multilayered sprocket tooth adapted for mounting on a hub of a drive sprocket has a plurality of separate tooth structures disposed in a side-by-side relationship.

### BRIEF DESCRIPTION OF THE DRAWINGS

A more complete understanding of the structure and operation of the present invention may be had by reference to the following detailed description when taken in conjunction with the accompanying drawings, wherein:

FIG. 1 is a diagrammatic side elevational view of a vehicle incorporating the sprocket assembly embodying the present invention;

FIG. 2 is an enlarged diagrammatic side elevational view, partly in section, of the sprocket assembly embodying the present invention;

FIG. 3 is a diagrammatic sectional view taken generally along the line 3-3 of FIG. 2;

FIG. 4 is a diagrammatic three-dimensional view of multilayered drive tooth segments representing one embodiment of the present invention; and

FIG. 5 is a diagrammatic side elevational view illustrating a second embodiment of multilayered drive tooth segments embodying the present invention.

### BEST MODE FOR CARRYING OUT THE INVENTION

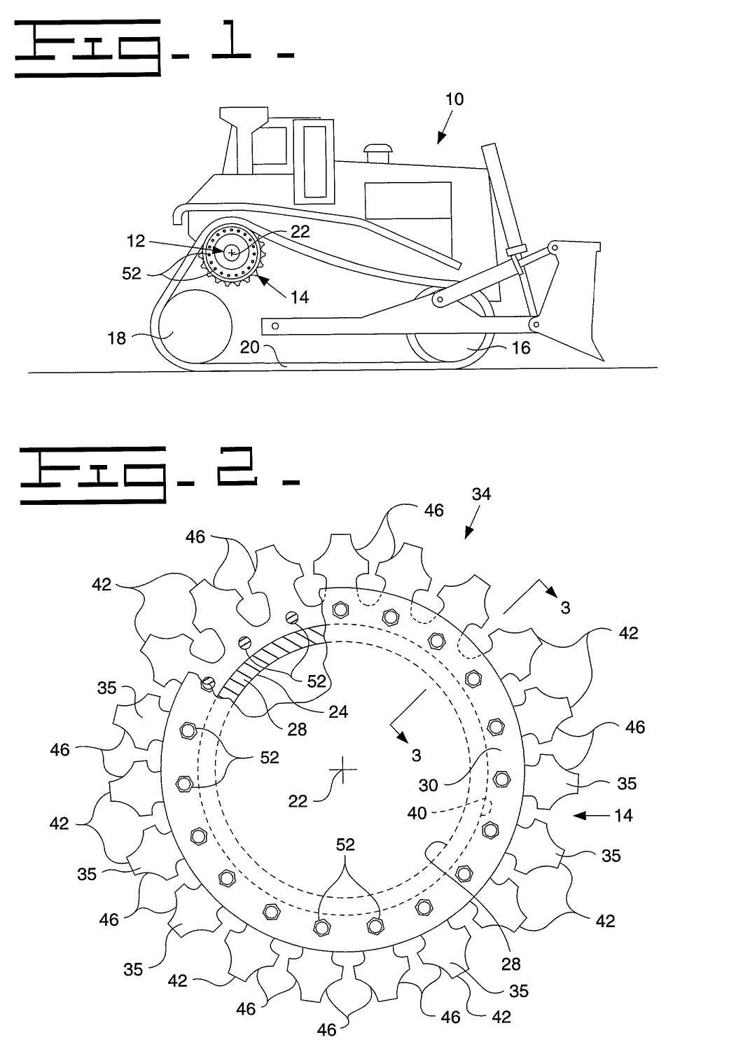

With specific reference to FIG. 1 of the drawings, a vehicle 10, such as a track-type tractor 10, has a powered drive system 12, a resilient drive sprocket assembly 14 embodying the present invention, first and second idler wheels 16, 18, and an endless track chain assembly 20 which encircles the sprocket assembly 14 and the idler wheels 16, 18. The sprocket assembly 14 is adapted to transfer power from the vehicle 10 to the track assembly 20. It is to be understood that many of the vehicle components, including the sprocket assembly 14, the idler wheel 16, 18 and the track chain assembly 20 are duplicated on the side of the vehicle 10 which is not illustrated. Since these duplicate components operate in the same manner as those shown, the description and operation of the components illustrated applies to both sides of the vehicle.

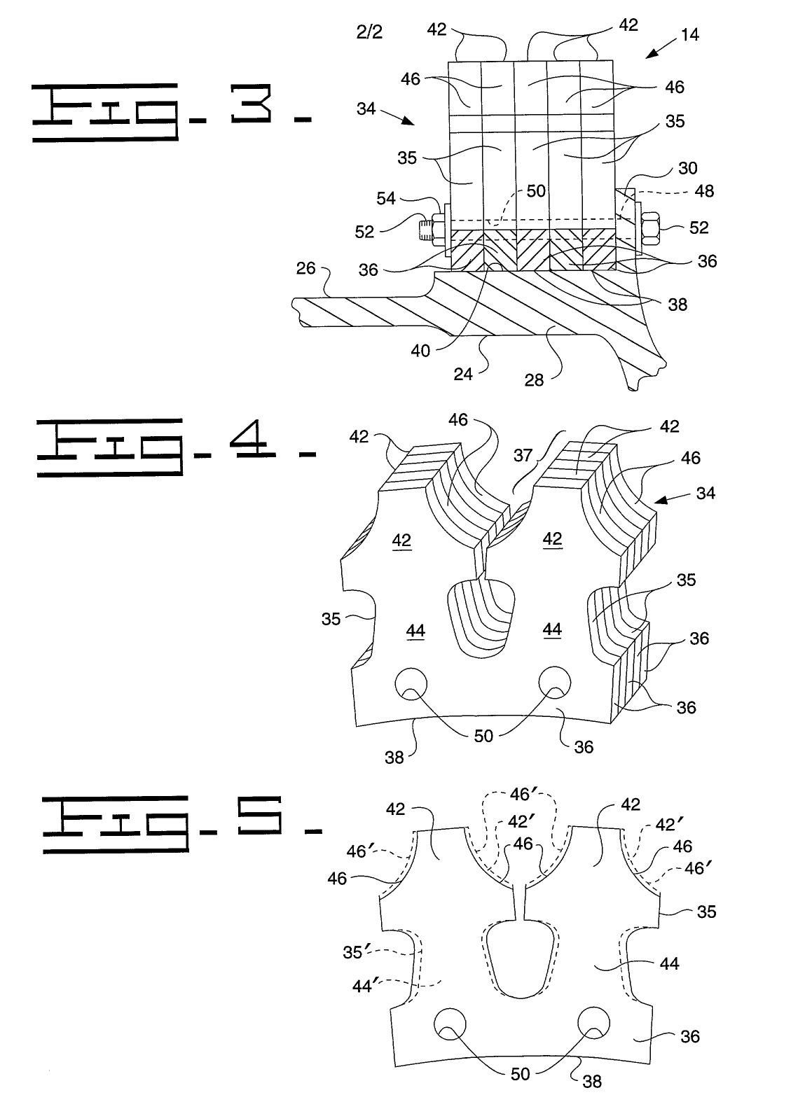

The resilient drive sprocket assembly 14 rotates about a central axis 22 as identified in FIGS. 1 and 2. With additional reference to FIG. 3, the resilient drive sprocket assembly 14 embodying a preferred embodiment of the present invention has a housing 24 having a mounting portion 26, a circular hub portion 28, and a circular flange 30 extending radially outwardly from the hub portion, all concentrically disposed about the axis of rotation 22.

As illustrated in FIGS. 3 and 4, the drive sprocket assembly 14 embodying the present invention further includes a plurality of circumferentially adjacent, multilayered drive tooth structures which are generally identified in FIGS. 2-4 by reference numeral 34. The drive tooth structures 34 are formed of multiple layers of curved segments 35, each having a base portion 36 which has a curved bottom surface 38 adapted to mate with a radially outer surface 40 of the hub portion 28. If so desired, the drive tooth structures 34 could be constructed as a plurality of segments 35 each shaped as a complete circle.

Each of the curved segments 35 of the drive tooth structures 34 also have at least one, and preferably two or more, resilient tooth portions 42. Each of the tooth portions 42 is capable of limited deflection as a result of a reduced cross-sectional web 44 between a radially outer track assembly engaging surface 46 and the base portion 36 of the drive tooth segments 42, and the spaced separation provided between circumferentially adjacent multilayered tooth portions 42.

A plurality, for example five, as shown in the illustrated embodiment, of the curved segments 35 are adjacently positioned, in side-by-side relationship, on the hub portion 28 of the housing 24. Thus, the separate resilient tooth portions 42 of a plurality of the curved segments 35 cooperate to define a single wide drive tooth 37 of the multilayered drive tooth structures 34 as illustrated by a bracket in FIG. 4.

A plurality of equally spaced holes 48 respectively extend through the flange 30. The base portion 36 of each of the curved segments 35 also have at least one hole 50 that is aligned with a respective hole 48 provided in the flange 30. The resilient drive sprocket assembly 14 also has a plurality of bolts 52 extending through the aligned holes 48 in the flange 30 and a respective one of the holes 50 in the base portion 36 of each of the curved segments 35. The bolts 52, and consequently the curved segments 35 captured thereby, are fixedly retained in place by a nut 54 threadably attached to the distal end of each of the bolts 52.

As described above, each of the resilient drive teeth 42 have limited deflectability, i.e., resiliency or moveability, as a result of the reduced cross-sectional area of the web 44. Conventional sprockets on a track-type tractor undercarriage system typically have very wide monolithic teeth and, consequently, each tooth has a high mass. Impact on wide monolithic teeth produce considerable noise as a result of the single impact between the wide tooth and a bushing component of the track assembly. Due to normal manufacturing tolerances, the profiles of the resilient tooth portions 42 of the curved segments 35 in the drive sprocket assembly 14 embodying the present invention will normally vary, and the impact between the separate track assembly engaging surfaces 46 in each multilayered tooth structure 34 and the track assembly bushing do not occur simultaneously, as is the case with a wide monolithic tooth. Thus, the multilayered construction of the drive tooth structures 34 embodying the present invention results in multiple impacts, potentially one impact per layer. Moreover, the independent flexibility of each tooth portion 42 in the multilayered construction is less than that of a single wide monolithic tooth.

Additionally, the multilayered drive tooth structures 34 provide increased frictional damping so that the sprocket assembly 14 has less ringing and noise transmission due to impacts.

As mentioned above, each of the resilient tooth portions 42 will vary from each other as a result of normal manufacturing tolerances. As a result of such variation, the stiffness of each of the resilient drive teeth 42 will vary somewhat from the drive teeth 42 formed on an adjacently disposed curved segment 35.

If so desired, the stiffness variation can be further increased by purposely modifying, e.g., such as by reducing or increasing the cross-sectional area of the webs 44, 44′ of adjacently disposed curved segments 35, 35′, as illustrated in FIG. 5. In FIG. 5, a first curved segment 35 and its associated components are identified by the reference numerals designated in the above description, and the viewable components of a second modified curved segment 35′ are identified by the same reference numerals with an added prime mark (′). As illustrated in FIG. 5, the profile shape of the resilient tooth portions 42, 42′ may also be intentionally modified to assure nonsimultaneous impact of the track engaging surfaces 46, 46′ with the track assembly 20. In such arrangement, the modified teeth 42′ not only have more flexibility, as a result of a reduced cross-sectional area of web 44′, but its track engaging surface 46′ also stands above the track engaging surface 46 of the adjacently disposed less flexible tooth 42. This results in the track bushing engaging first on the more flexible modified teeth 42′ which absorb much of the kinetic energy prior to impacting on the less flexible resilient drive teeth 42 in a multilayered structure.

The resilient drive tooth structures may also be formed of different materials or otherwise designed to have varying spring rates to provide specific load/deflection properties. Each of the curved segments 35, 35′ may include only a single resilient drive tooth in the manner described in the aforementioned U.S. Pat. No. 4,881,930, or more desirably, a plurality of circumferentially spaced resilient drive teeth 42, 42′ e.g., three or more.

Industrial Applicability

The multilayered resilient drive sprocket assembly 14 embodying the present invention is particularly useful with earth moving equipment, and more specifically, self-laying track-type vehicles such as the vehicle 10. Power from the engine of the vehicle 10 is transmitted to the drive system 12 which then rotates the sprocket assembly 14. As the sprocket assembly 14 rotates, the separate resilient drive teeth 42 in the multilayered tooth structure 34 contact portions of the track chain assembly 20 in individual, nonsimultaneous impacts, thereby propelling the vehicle 10. The track bushings of the track assembly 20 thus engage the multilayered resilient drive teeth 42, potentially one at a time. Because each of the resilient drive teeth 42 have less stiffness than that of a single monolithic wide drive tooth structure, the earlier contacting resilient drive teeth 42 will absorb at least a portion of the kinetic energy prior to the track bushing contacting other resilient drive tooth 42 in the multilayered drive tooth structures 34. This property allows the use of highly flexible tooth portions 42 without overstressing drive teeth under high load conditions.

The resilient drive sprocket assembly 14 embodying the present invention thus provides a reduced noise level sprocket assembly for driving a track assembly 20 by utilizing a plurality of multilayered drive tooth structures 34 which distribute the impact of the track assembly 20 on each drive tooth structure 34 over multiple contacts rather than a single contact. Additionally, the undercarriage components and power train of the vehicle 10 will experience lower stress since the resiliency of the drive sprocket assembly 14 embodying the present invention will distribute shock loads among multiple teeth. The multilayered tooth construction also provides increased frictional damping, and the drive sprocket 14 accordingly has less ringing due to impacts, thereby further contributing to noise reduction.

Other aspects, features, and advantages of this invention may be obtained from the study of this disclosure and the drawings, along with the appended claims.

1. A drive tooth sprocket assembly adapted for rotation about an axis thereof and comprising:
a housing having a circular hub portion concentrically disposed about said axis; and
at least one drive tooth structure having a plurality of adjacently disposed curved segments axially arranged along said axis of the drive sprocket assembly, each of said segments having a base portion with a curved surface adapted to mate with a radially outer surface of said hub portion of the housing and at least one resilient tooth portion capable of limited deflection extending radially outwardly from said base portion.

2. A drive sprocket assembly, as set forth in claim 1, wherein the tooth portions of said plurality of adjacently disposed curved segments are separately moveable and cooperate to provide a single multilayered drive tooth of said sprocket assembly.

3. A drive sprocket assembly, as set forth in claim 2, wherein said at least one drive tooth portion of a predefined one of said adjacently disposed curved segments has a first predefined stiffness and the drive tooth portion of an adjacently disposed one of said curved segments has a second predefined stiffness different than that of said first defined stiffness.

4. A drive sprocket assembly, as set forth in claim 2, wherein said at least one drive tooth portion of a predefined one of said adjacently disposed curved segments has a first predefined profile shape and the drive tooth portion of an adjacently disposed one of said curved segments has a second predefined profile shape different than that of said first defined profile shape.

5. A drive sprocket assembly, as set forth in claim 1, wherein said housing includes a circular flange extending radially outwardly from the hub portion and having a plurality of equally spaced holes extending respectively therethrough, and the base portion of each of said curved segments has at least one hole extending therethrough and aligned with a respective one of the holes in said flange, and said drive sprocket assembly includes a plurality of bolts each extending respectively through one of the holes in said flange and a respective aligned hole in the base portions of said plurality of adjacently disposed curved segments.

6. The drive sprocket assembly, as set forth in claim 1, wherein said drive sprocket assembly includes a plurality of adjacent circumferentially arranged drive tooth structures.

7. A drive sprocket assembly for a track-type vehicle, said vehicle having an endless track assembly, and said sprocket assembly being adapted to transfer power from the vehicle to the track assembly, said drive sprocket assembly comprising:
a housing having a circular hub portion; and
a plurality of segments disposed in side-by-side relationship on said hub portion, each of said segments having at least one drive tooth portion adapted to engage a predefined portion of said endless track assembly.

8. The drive sprocket assembly, as set forth in claim 7, wherein said at least one tooth portion of one of said plurality of segments is separately moveable with respect to said at least one tooth portion of adjacently disposed segments and cooperates with the at least one tooth portion of said adjacently disposed segments to provide a single multilayered drive tooth of said sprocket assembly.

9. The drive sprocket assembly, as set forth in claim 7, wherein the drive tooth portion of one of said adjacently disposed segments has a first predefined stiffness and the drive tooth portion of another one of said adjacently disposed segments has a second predefined stiffness different than that of said first defined stiffness.

10. The drive sprocket assembly, as set forth in claim 7, wherein the drive tooth portion of one of said adjacently disposed segments has a first predefined profile shape and the drive tooth portion of another one of said adjacently disposed segments has a second predefined profile shape different than that of said first defined profile shape.

11. The drive sprocket assembly, as set forth in claim 7, wherein said housing includes a circular flange extending radially outwardly from the hub portion and having a plurality of equally spaced holes extending respectively therethrough, and each of said segments has a base portion adapted to mate with an outer surface of said circular hub portion, the base portion of each of said segments having at least one hole extending therethrough and aligned with a respective one of said holes in the flange, and said drive sprocket assembly includes a plurality of bolts each of which extend through one of the holes in said flange and a respective aligned hole in the base portions of said plurality of segments disposed in side-by-side relationship.

12. A multilayered sprocket tooth adapted for mounting on a hub of a drive sprocket, said multilayered sprocket tooth comprising a plurality of segments disposed in side-by-side relationship and having at least one flexible tooth portion provided thereon.

13. The multilayered sprocket tooth, as set forth in claim 12, wherein the flexible tooth portion of one of the segments disposed in side-by-side relationship has a first predefined stiffness and the flexible tooth portion of another one of said segments disposed in side-by-side relationship has a second predefined stiffness different than that of said first predefined stiffness.

14. The multilayered sprocket tooth, as set forth in claim 12, wherein the flexible tooth portion of one of the segments disposed in side-by-side relationship has a first predefined profile shape and the flexible tooth portion of another one of said segments disposed in side-by-side relationship has a second predefined profile shape different than that of said first predefined profile shape.
